(19) United States
(12) Patent Application Publication
(10) Pub. No.: US 2024/0283552 A1
(43) Pub. Date: Aug. 22, 2024

(54) Autonomous Detection and Reporting Of UE-To-UE CLI

(71) Applicant: MediaTek Singapore Pte. Ltd., Singapore (SG)

(72) Inventors: Sumaila Anning Mahama, Cambridge (GB); Rama Kiran, Bengaluru (IN); Mohammed S Aleabe Al-Imari, Cambridge (GB)

(21) Appl. No.: 18/429,122

(22) Filed: Jan. 31, 2024

(30) Foreign Application Priority Data
Feb. 17, 2023 (IN) 202321010921

(51) Int. Cl. H04B 17/345; H04L 5/00; H04W 24/08; H04W 24/10

(52) U.S. Cl. CPC H04B 17/345; H04L 5/0051; H04W 24/08; H04W 24/10

(57) ABSTRACT

Techniques pertaining to autonomous detection and reporting of user equipment (UE)-to-UE cross link interference (CLI) are described. A UE detects that a value of an interference measurement for at least one of one or more reference signals or one or more channels used by the UE to communicate with a network node indicates that an interference has exceeded an interference threshold. In response to the detecting, the UE then reports the value of the interference measurement to the network node as a CLI measurement of UE-to-UE CLI experienced by the UE.

### CROSS REFERENCE TO RELATED PATENT APPLICATION(S)

The present disclosure is part of a non-provisional application claiming the priority benefit of Indian Patent Application No. 202321010921, filed 17 Feb. 2023, the content of which herein being incorporated by reference in its entirety.

### TECHNICAL FIELD

The present disclosure is generally related to mobile communications and, more particularly, to the measurement and reporting of Cross Link Interference (CLI) for subband-full duplex (SBFD) networks.

### BACKGROUND

Unless otherwise indicated herein, approaches described in this section are not prior art to the claims listed below and are not admitted as prior art by inclusion in this section.

In 3GPP Release 19, UEs are full-duplex, meaning that each UE is able to transmit and receive data simultaneously over resources that overlap in time while communicating with a base station (e.g., a gNB). Thus, UEs under 3GPP Release 19 are able to provide higher maximum data throughput and lower latency. However, the simultaneous transmission and reception of data over resources that overlap in time by multiple UEs may lead to problems such as UE-to-UE cross link interference (CLI). UE-to-UE CLI occurs when a UE that is receiving in the uplink is experiencing interference from another UE that is transmitting in the downlink, or vice versa.

Currently, there are schemes that enable a UE to report such CLI to a base station such that the base station may make informed decisions as to the scheduling of data transmission and data reception for various UEs. Under these schemes, there are two main types of reporting: (1) event triggered CLI reporting and (2) periodic CLI reporting.

In event triggered CLI reporting, a reporting condition has to be satisfied for a UE to report one or more dedicated CLI measurements (e.g., sounding reference signal-reference signal received power (SRS-RSRP) or CLI-received signal strength indicator (CLI-RSSI)) to a base station. For example, the reporting condition may be that an interference, as measured by a CLI measurement, becomes higher than a predetermined interference threshold. Such measurements may be linked to specific reports. In some instances, the base station may configure a time interval between reports, such that multiple reports may be sent by the UE according to the time interval. Further, the base station may further terminate the reporting when a leaving condition is satisfied. For example, the reporting may be terminated when the interference is no longer higher than the predetermined interference threshold.

In periodic CLI reporting, the base station may configure a time interval between reports, such that multiple CLI reports may be sent by the UE to the base station according to the time interval. For each reporting by the UE, each of one or more CLI measurements may be reported when a corresponding value of the CLI measurement is available.

However, there are some issues with the current event triggered and periodic CLI reporting schemes. A first issue is that multiple UEs may need to be configured to use dedicated UE resources in order for a particular UE to perform CLI measurements. For example, a first UE has to be configured by the base station to use certain UE resources to transmit data via an uplink, and a second UE has to be configured by the base station to simultaneously use dedicated CLI measurement resources (e.g., SRS-RSRP measurement resources, CLI-RSSI measurement resources, etc.) to perform the CLI measurements with respect to the transmission of the data via the uplink by the first UE. However, the configuration and use of such UE resources to perform CLI measurements adds resource usage overhead to UEs that may adversely impact UE performance. A second issue is that with multiple UEs performing full-duplex communication, the scheduling of data transmissions and receptions for the UEs may be rapidly and dynamically changing. Therefore, the performance of CLI measurements must be done quickly and frequently to accurately capture the CLI conditions experienced by the UEs. However, such repeated and frequent performance of CLI measurements using dedicated CLI measurement resources may further add to the resource usage overhead of the UEs. Therefore, there is a need for a solution that provides for the efficient autonomous detection and reporting of UE-to-UE CLI.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions that provide for the autonomous detection and reporting of UE-to-UE CLI. It is believed that implementations of various proposed schemes in accordance with the present disclosure may address or otherwise alleviate issues described herein.

In one aspect, a method may include a UE detecting that a value of an interference measurement for at least one of one or more reference signals or one or more channels used by the UE to communicate with a network node indicates that an interference has exceeded an interference threshold. The method may also include the UE, in response to the detecting, reporting the value of the interference measurement to the network node as a CLI measurement of UE-to-UE CLI experienced by the UE.

In another aspect, a method may include a UE determining that an entering condition for triggering reporting of UE-to-UE CLI experienced by the UE is satisfied when a value of an interference measurement for at least one of a reference signal or a channel used by the UE to communicate with a network node indicates that an interference has exceeded an interference threshold. The method may also involve the UE, in response to the determining, sending one or more reports of UE-to-UE CLI experienced by the UE that include one or more CLI measurements to a network node.

It is noteworthy that, although the description provided herein may be in the context of certain radio access technologies, networks, and network topologies such as 5G/NR mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example implementation in accordance with the present disclosure.

FIG. 3 is a block diagram of an example communication system in accordance with an implementation of the present disclosure.

FIG. 4 is a flowchart of a first example process in accordance with an implementation of the present disclosure.

FIG. 5 is a flowchart of a second example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes, and/or solutions pertaining to autonomous detection and reporting of UE-to-UE CLI. According to the present disclosure, a number of possible solutions may be implemented separately or jointly. That is, although these possible solutions may be described below separately, two or more of these possible solutions may be implemented in one combination or another.

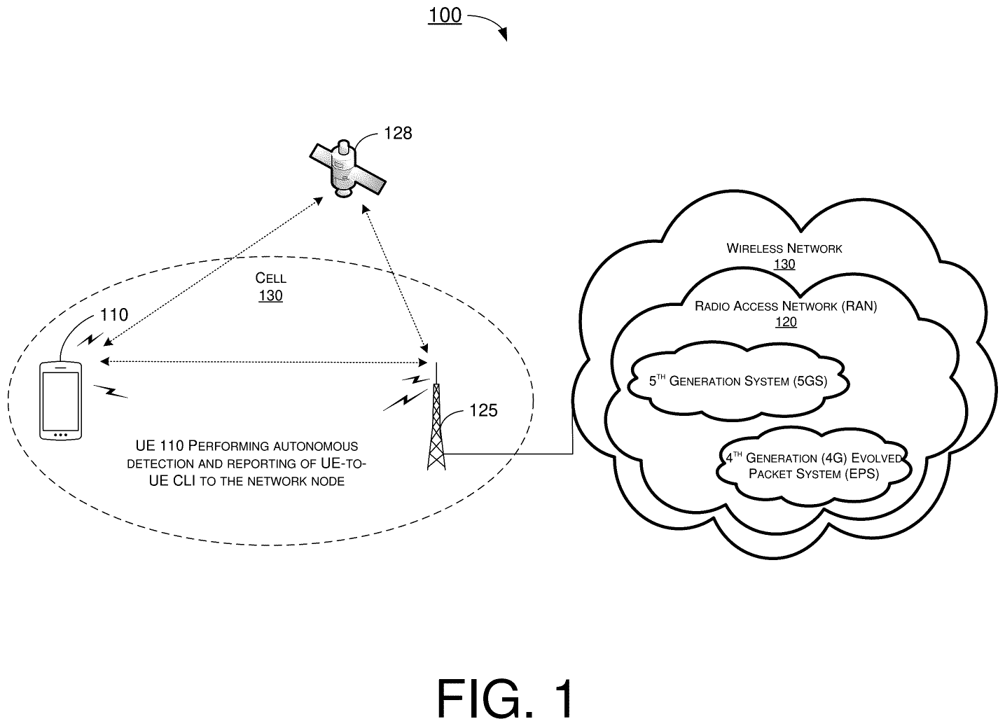

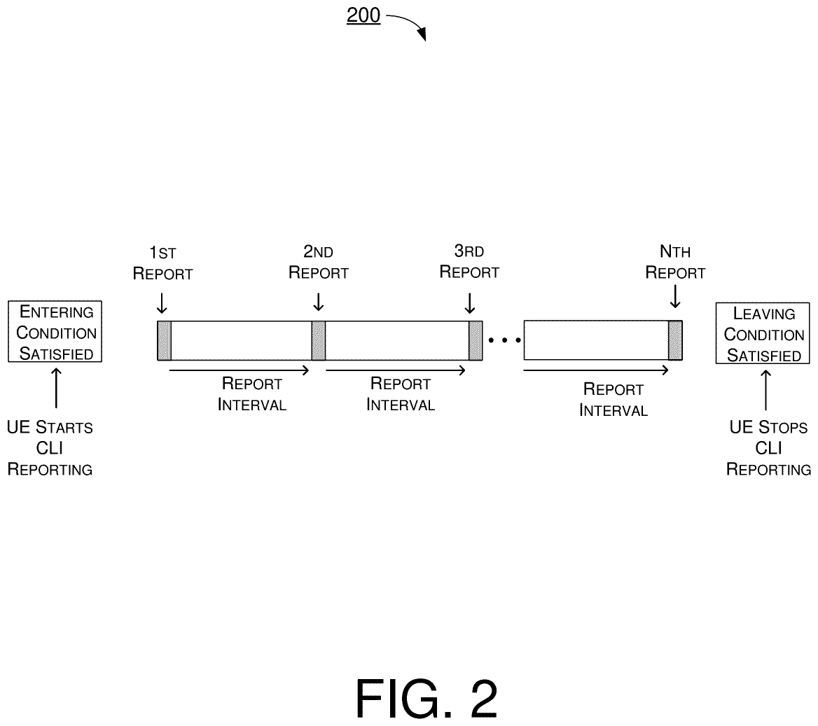

FIG. 1 illustrates an example network environment 100 in which various solutions and schemes in accordance with the present disclosure may be implemented. FIG. 2-FIG. 5 illustrate examples of implementation of various proposed schemes in network environment 100 in accordance with the present disclosure. The following description of various proposed schemes is provided with reference to FIG. 1-FIG. 5.

Referring to FIG. 1, network environment 100 may involve a UE 110 in wireless communication with a radio access network (RAN) 120 (e.g., a 5G NR mobile network or another type of network such as an NTN). UE 110 may be in wireless communication with RAN 120 via a base station or terrestrial network node 125 (e.g., an eNB, gNB or transmit-receive point (TRP)) and/or via a satellite or non-terrestrial network node 128. RAN 120 may be a part of a network 130. In network environment 100, UE 110 and network 130 (via terrestrial network node 125 or non-terrestrial network node 128 of RAN 120) may implement various schemes pertaining to autonomous detection and reporting of UE-to-UE CLI, also referred to herein as CLI, as described below. It is noteworthy that, although various proposed schemes, options, and approaches may be described individually below, in actual applications these proposed schemes, options, and approaches may be implemented separately or jointly. That is, in some cases, each of one or more of the proposed schemes, options, and approaches may be implemented individually or separately. In other cases, some or all of the proposed schemes, options, and approaches may be implemented jointly.

According to a first proposed scheme of the present disclosure, the UE 110 may be configured by the network node 125 to perform autonomous detection and reporting of UE-to-UE CLI without using dedicated measurement resources. Instead, the UE may be configured to use interference measurements for various reference signals and/or channels that are routinely used by the UE 110 to communicate with the network node 125 to detect and report CLI. Accordingly, the UE may report a value of a particular interference measurement for a reference signal and/or a channel as a CLI measurement to the network node 125 when a value of the particular interference measurement indicates that an interference to the reference signal and/or a channel exceeds a corresponding interference threshold.

For example, in one scenario, the interference measurement may be a signal to interference plus noise ratio (SINR) measurement for a signal, and the UE 110 may report the SINR measurement as a CLI measurement when the SINR measurement is below a predetermined SINR value threshold, as the SINR measurement being below the predetermined SINR value threshold indicates that interference has exceeded an interference threshold. In another scenario, the interference measurement may be an error rate, e.g., block error rate (BER) for a communication channel, and the UE 110 may report the error rate as a CLI measurement when the error rate exceeds a predetermined error rate value threshold, as the error rate value threshold serves as the interference threshold.

In some implementations, the reference signals used by the UE 110 to detect CLI may include a demodulation reference signal (DMRS) that is received by the UE 110, such as a DMRS that is transmitted as a part of a downlink channel, e.g., the physical data shared channel (PDSCH) or as a part of a downlink control channel, e.g., the physical downlink control channel (PDCCH). For example, when an estimated channel quality value that is estimated based on the DMRS is below a channel quality value threshold (e.g., poor channel quality), thereby indicating that an interference has exceeded an interference threshold, the UE 110 may report the estimated channel quality value as a CLI measurement.

In related implementations, the reference signals may include a DMRS sequence that is orthogonal to the DMRS used in the PDSCH or the PDCCH by the network node 125 or another network node of the RAN 120. The orthogonal sequence may enable effective UE-to-UE CLI detection by exploiting the low cross-correlation property between two orthogonal DMRS sequences. In some instances, the DMRS orthogonal sequence may be provided to the UE 110 via higher layer signaling (e.g., Layer 3 signaling) from the network node 125.

In other implementations, the reference signals used by the UE 110 to detect CLI may include a channel state information reference signal (CSI-RS). For example, when an amount of interference to the reception of the CSI-RS by the UE 110 exceeds an interference threshold, the UE 110 may report the amount of interference to the CSI-RS as a CLI measurement to the network node 125. In this way, the UE 110 may use existing wireless communication mechanisms and procedures to autonomously detect and report UE-to-UE CLI without utilizing dedicated CLI measurement resources.

According to a second proposed scheme, the UE 110 may be configured with a framework for reporting the autonomously detected CLI measurements. In some implementations, the reporting of the autonomously detected CLI measurements by the UE 110 may be event triggered, such as by a measured value for interference to a reference signal and/or channel that is configured to represent CLI exceeding a corresponding value threshold that serves as an interference threshold. For example, in one instance, the UE 110 may be triggered to report a CLI when a value of an interference or a value for a number of channel estimation errors experienced by the UE 110 during a reception of a DMRS for the PDSCH exceeds a corresponding value threshold. In other instances, the UE 110 may be triggered to report a CLI when a value of an interference or a value for a number of channel estimation errors experienced by the UE 110 during the reception of a DMRS for the PDCCH exceeds a corresponding value threshold. In an additional instance, the UE 110 may be triggered to report a CLI when a value of an interference or an error rate experienced by the UE 110 during a PDSCH exceeds a corresponding value threshold. In further instances, the UE 110 may be triggered to report a CLI when a value of an interference experienced by the UE 110 when generating a channel quality indicator (CQI) report exceeds a corresponding value threshold.

In some implementations, the UE 110 may be configured by the network node 125 to use particular resources to report the detected CLI. For example, in some instances, the UE 110 may be configured to use specific slots and/or symbols in an uplink to the network node 125 to report the detected CLI to the network node 125. In another example, the UE 110 may be configured to use one or more specific resource blocks in an uplink to the network node 125 to report the detected CLI to the network node 125. In additional embodiments, the UE 110 may be configured to report the detected CLI to the network node 125 via PUCCH resources or physical uplink shared channel (PUSCH) resources.

In some implementations, the UE 110 may be configured by the network node 125 to use particular values in the CLI reports that are indicative of the presence and/or levels of CLI. In one scenario, the UE 110 may be configured to use a single bit to indicate the presence and/or level of CLI. For example, the UE 110 may be configured to report a bit value of 0 to indicate a low level of CLI and a bit value of 1 to indicate a high level of CLI. In another example, the UE 110 may be configured to report a bit value of 1 to indicate a presence of CLI. In such implementations, the UE 110 may correlate different ranges of interference measurement values for reference signals and/or channels to the different levels/presence of CLI in order to report the bit values that correspond to the different levels/presence. For example, a range of non-zero interference measurement values may correlate to a presence of CLI. In another example, a first range of interference measurement values may correlate to a low level of CLI, and a second range of interference measurement values may correlate to a high level of CLI.

In another scenario, the UE 110 may be configured to use two-bit values to indicate a level of CLI. For example, the UE 110 may be configured to report a value of 00 to indicate a low level of CLI that does not cause a decoding failure, a value of 01 to indicate a low level of CLI that causes decoding failure, a value of 10 to indicate a high level of CLI that causes decoding failure, and a value of 11 to indicate a severe level of CLI that causes complete blockage. Thus, the UE 110 may correlate different ranges of interference measurement values for reference signals and/or channels to the different levels/presence of CLI in order to report bit values that correspond to the different levels. For example, a first range of interference measurement values may correlate to a first level of CLI, a second range of interference measurement values may correlate to a second level of CLI, a third range of interference measurement values may correlate to a third level of CLI, and so forth.

In an additional scenario, the UE 110 may be configured to report bit values that serve as pointers to a table that is stored by the network node 125, in which the table defines different CLI levels or different CLI values for various bit values. Thus, the table may translate different bit values (e.g., 3-bit values) to corresponding different CLI conditions (e.g., a presence of CLI, a low level of CLI, a high level of CLI, a severe level of CLI, different CLI values, etc.). For example, when the UE 110 reports a 3-bit value of 001 to the network node 125, the network node 125 may use the table to translate the 3-bit value of 001 to a particular CLI value or CLI level.

In some implementations, the UE 110 may be configured to report the one or more resources for which CLI was detected to the network node 125. For example, the UE 110 may be configured to report the one or more specific slots/symbols for which CLI was detected, the one or more specific resource blocks for which CLI was detected, and/or the one or more specific transport blocks for which CLI was detected. In turn, the network node 125 may use such information to determine one or more UEs that were scheduled to use one or more resources for which CLI was detected. In this way, the network node 125 may determine the identities of the one or more UEs that are causing CLI to the UE 110. Accordingly, the network node 125 may schedule the one or more UEs that caused the CLI to use one or more different resources in order to avoid further CLI to the UE 110.

In some implementations, the UE may be configured by the network node 125 to send different numbers of CLI reports to the network node 125 in different scenarios. For example, in one scenario, the UE 110 may be configured to send one or more reports of the detected CLI until a predetermined number of reports have been sent. At this point, the UE 100 may stop sending any additional reports of detected CLI even when one or more additional CLIs are detected.

In another scenario, the UE 110 may be configured with a reporting interval that is a time duration between consecutive reports, such that the UE 110 may send reports of the detected CLI according to the reporting interval. For example, the UE 110 may report CLIs according to the reporting interval regardless of the frequency which CLIs are actually detected.

In another instance, the UE 110 may be configured with a leaving condition for CLI reporting. For example, the leaving condition may be an event in which a particular interference value that is being measured by the UE 110 for CLI becomes lower than a corresponding value threshold. Accordingly, the UE 110 may stop the CLI reporting when the leaving condition is satisfied.

FIG. 2 is a diagram of an example implementation in accordance with the present disclosure. As shown in FIG. 2, the UE 110 may start sending CLI reports to the network node 125 when an entering condition is satisfied. The UE 110 may send consecutive CLI reports to the network node 125 using scheduled resources according to the configured reporting interval. Subsequently, the UE 110 may stop sending the CLI reports to the network node 125 when a leaving condition is satisfied. Alternatively, the UE 110 may stop sending the CLI reports when a preconfigured number of CLI reports are sent.

In some alternative implementations, the UE 110 may be configured by the network node 125 to perform semi-persistent reporting of CLI to the network node 125. For example, the UE 110 may perform periodic reporting when resources (e.g., slots, symbols, resource blocks, etc.) are scheduled to be available to the UE 110 to support the reporting of CLIs according to a reporting interval. The configuration of the resources for semi-persistent reporting of CLI by the UE 110 may be provided by the network node 125 using higher layer signaling (e.g., Layer 3 signaling). Alternatively, or concurrently, the reporting of the detected CLI measurements to the network node 125 by the UE 110 may be activated and/or deactivated using Layer 1 signaling. Thus, it will be appreciated that the various implementations described above may be used singularly or in any combination to achieve the autonomous detection and reporting of UE-to-UE CLI between the UE 110 and at least one other UE.

### Illustrative Implementation

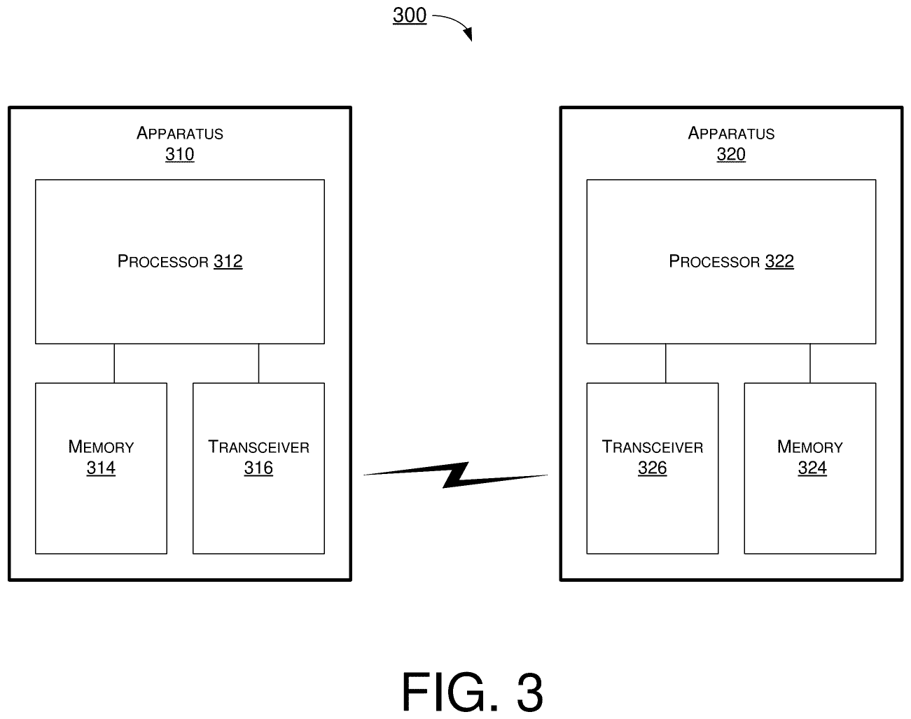

FIG. 3 illustrates an example communication system 300 having at least an example apparatus 310 and an example apparatus 320 in accordance with an implementation of the present disclosure. Each of apparatus 310 and apparatus 320 may perform various functions to implement schemes, techniques, processes and methods described herein pertaining to autonomous detection and reporting of UE-to-UE CLI, including the various schemes described above with respect to various proposed designs, concepts, schemes, systems and methods described above, including network environment 100, as well as processes described below.

Each of apparatus 310 and apparatus 320 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 310 and apparatus 320 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 310 and apparatus 320 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 310 and apparatus 320 may be implemented in a smart thermostat, a smart fridge, a smart door lock, a wireless speaker or a home control center. When implemented in or as a network apparatus, apparatus 310 and/or apparatus 320 may be implemented in an eNodeB in an LTE, LTE-Advanced or LTE-Advanced Pro network or in a gNB or TRP in a 5G network, an NR network or an IoT network.

In some implementations, each of apparatus 310 and apparatus 320 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 310 and apparatus 320 may be implemented in or as a network apparatus or a UE. Each of apparatus 310 and apparatus 320 may include at least some of those components shown in FIG. 3 such as a processor 312 and a processor 322, respectively, for example. Each of apparatus 310 and apparatus 320 may further include one or more other components not pertinent to the proposed scheme of the present disclosure (e.g., internal power supply, display device and/or user interface device), and, thus, such component(s) of apparatus 310 and apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC or RISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including those pertaining to autonomous detection and reporting of UE-to-UE CLI in accordance with various implementations of the present disclosure.

In some implementations, apparatus 310 may also include a transceiver 316 coupled to processor 312. Transceiver 316 may be capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs/wireless networks of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, apparatus 310 may further include a memory 314 coupled to processor 312 and capable of being accessed by processor 312 and storing data therein. In some implementations, apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Each of apparatus 310 and apparatus 320 may be a communication entity capable of communicating with each other using various proposed schemes in accordance with the present disclosure. For illustrative purposes and without limitation, a description of capabilities of apparatus 310, as a UE (e.g., UE 110), and apparatus 320, as a network node (e.g., terrestrial network node 125 or non-terrestrial network node 128) of a network (e.g., network 130 as a 5G/NR mobile network), is provided below in the context of example processes 400 and 500.

### Illustrative Processes

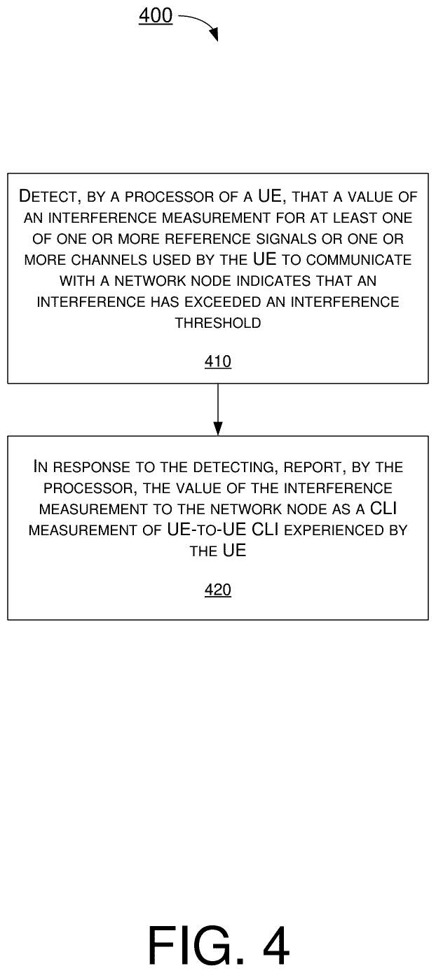

FIG. 4 illustrates an example process 400 in accordance with an implementation of the present disclosure. Process 400 may represent an aspect of implementing various proposed designs, concepts, schemes, systems and methods described above, whether partially or entirely, including those pertaining to those described above. More specifically, process 400 may represent an aspect of the proposed concepts and schemes pertaining to autonomous detection and reporting of UE-to-UE CLI. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 310 and apparatus 320 as well as any variations thereof. Solely for illustrative purposes and without limiting the scope, process 400 is described below in the context of apparatus 310 as a UE (e.g., UE 110) and apparatus 320 as a communication entity such as a network node or base station (e.g., terrestrial network node 125 or non-terrestrial network node 128) of a network (e.g., network 130 as a 5G/NR mobile network). Process 400 may begin at block 410.

At 410, process 400 may involve processor 312 of apparatus 310 detecting that a value of an interference measurement for at least one of one or more reference signals or one or more channels used by the UE to communicate with a network node indicates that an interference has exceeded an interference threshold. Process 400 may proceed from 410 to 420.

At 420, process 400 may involve processor 312 reporting, via transceiver 316, in response to the detecting, the value of the interference measurement to the network node as a cross link interference (CLI) measurement of UE-to-UE CLI experienced by the UE.

In some implementations, the one or more reference signals may include a DMRS that is transmitted as a part of a PDSCH or a PDCCH. In other implementations, the one or more reference signals may include a demodulation reference signal (DMRS) sequence. For example, the DMRS sequence may be an orthogonal DMRS sequence that is orthogonal to a DMRS used in a PDSCH or a PDCCH by the network node or another network node. The orthogonal DMRS sequence may enable detection of the UE-to-UE CLI by exploiting a low cross-correlation property between two orthogonal DMRS sequences. The orthogonal DMRS sequence may be provided to the UE via a higher layer signaling by the network node. In additional implementations, the one or more reference signals may include CSI-RS.

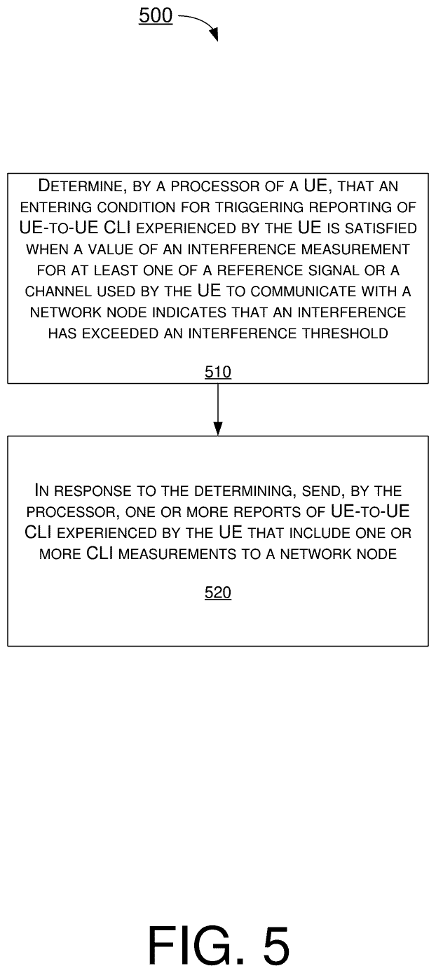

FIG. 5 illustrates an example process 500 in accordance with an implementation of the present disclosure. Process 500 may represent an aspect of implementing various proposed designs, concepts, schemes, systems and methods described above, whether partially or entirely, including those pertaining to those described above. More specifically, process 500 may represent an aspect of the proposed concepts and schemes pertaining to autonomous detection and reporting of UE-to-UE CLI. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in apparatus 310 and apparatus 320 as well as any variations thereof. Solely for illustrative purposes and without limiting the scope, process 500 is described below in the context of apparatus 310 as a UE (e.g., UE 110) and apparatus 320 as a communication entity such as a network node or base station (e.g., terrestrial network node 125 or non-terrestrial network node 128) of a network (e.g., network 130 as a 5G/NR mobile network). Process 500 may begin at block 510.

At 510, process 500 may involve processor 312 of apparatus 310 determining that an entering condition for triggering reporting of UE-to-UE CLI experienced by the UE is satisfied when a value of an interference measurement for at least one of a reference signal or a channel used by the UE to communicate with a network node indicates that an interference has exceeded an interference threshold.

At 520, process 500 may involve processor 312 sending in response to the determining, via transceiver 316, one or more reports of UE-to-UE cross link interference (CLI) experienced by the UE that include one or more CLI measurements to a network node.

In some implementations, the one or more CLI measurements may include the value of the interference measurement for the interference to the at least one of the reference signal or the channel.

In some implementations, the value of the interference measurement may be an interference value or a value for a number of channel estimation errors measured during a reception of a DMRS for a PDSCH or during a reception of an additional DMRS for a PDCCH, and the entering condition is satisfied when the value of the interference measurement exceeds a corresponding value threshold.

In some implementations, the value of the interference measurement may be an interference value or an error rate value measured during a PDCCH reception, and the entering condition is satisfied when the value of the interference measurement exceeds a corresponding value threshold.

In some implementations, the value of the interference measurement may be an interference value measured during a generation of a channel quality indicator (CQI) report, and the entering condition is satisfied when the value of the interference measurement exceeds a corresponding value threshold.

In some implementations, the sending may include sending the one or more reports via one or more slots, one or more symbols, one or more resource blocks, one or more PDCCH resources, or one or more PUSCH resources that are configured by the network node.

In some implementations, the sending of the one or more reports may include sending a report that includes a bit value that indicates a level of the UE-to-UE CLI or a bit value that serves as a pointer to a table that defines different UE-to-UE CLI levels or different UE-to-UE CLI values for various bit values.

In some implementations, the sending of the one or more reports may include sending a report that indicates a resource on which the UE-to-UE CLI is detected, the resource including one or more slots, one or more symbols, one or more resource blocks, or one or more transport blocks.

In some implementations, process 500 may further involve processor 312 performing additional operations. For instance, process 500 may involve processor 312 stopping the sending of the one or more reports to the network node when a leaving condition is satisfied, and wherein the leaving condition is satisfied when the value of an interference measurement no longer exceeds the interference threshold. Alternatively, process 500 may involve processor 312 stopping the sending of the one or more reports to the network node when a preconfigured number of reports are sent. In some implementations, the sending of the one or more reports may include sending consecutive reports according to a reporting interval configured by the network node. In some implementations, the sending of the one or more reports may include performing semi-persistent sending of the one or more reports using resources that are configured via a higher layer signaling by the network node. In some implementations, the sending of the one or more reports may be further deactivated or activated by the network node using Layer 1 signaling.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mate able and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
detecting, by a processor of a user equipment (UE), that a value of an interference measurement for at least one of one or more reference signals or one or more channels used by the UE to communicate with a network node indicates that an interference has exceeded an interference threshold; and
in response to the detecting, reporting, by the processor, the value of the interference measurement to the network node as a cross link interference (CLI) measurement of UE-to-UE CLI experienced by the UE.

2. The method of claim 1, wherein the one or more reference signals include a demodulation reference signal (DMRS) that is transmitted as a part of a physical data shared channel (PDSCH) or a physical downlink control channel (PDCCH).

3. The method of claim 1, wherein the one or more reference signals include a demodulation reference signal (DMRS) sequence.

4. The method of claim 3, wherein the DMRS sequence is an orthogonal DMRS sequence that is orthogonal to a DMRS used in a physical data shared channel (PDSCH) or a physical downlink control channel (PDCCH) by the network node or another network node.

5. The method of claim 4, wherein the orthogonal DMRS sequence enables detection of the UE-to-UE CLI by exploiting a low cross-correlation property between two orthogonal DMRS sequences.

6. The method of claim 4, wherein the orthogonal DMRS sequence is provided to the UE via a higher layer signaling by the network node.

7. The method of claim 1, wherein the one or more reference signals include a channel state information reference signal (CSI-RS).

8. A method, comprising:
determining, by a processor of a user equipment (UE), that an entering condition for triggering reporting of UE-to-UE cross link interference (CLI) experienced by the UE is satisfied when a value of an interference measurement for at least one of a reference signal or a channel used by the UE to communicate with a network node indicates that an interference has exceeded an interference threshold; and
in response to the determining, sending, by the processor, one or more reports of CLI experienced by the UE that include one or more CLI measurements to a network node.

9. The method of claim 8, wherein the one or more CLI measurements include the value of the interference measurement for the interference to the at least one of the reference signal or the channel.

10. The method of claim 8, wherein the value of the interference measurement is an interference value or a value for a number of channel estimation errors measured during a reception of a demodulation reference signal (DMRS) for a physical data shared channel (PDSCH) or during a reception of an additional DMRS for a physical downlink control channel (PDCCH), and wherein the entering condition is satisfied when the value of the interference measurement exceeds a corresponding value threshold.

11. The method of claim 8, wherein the value of the interference measurement is an interference value or an error rate value measured during a physical downlink control channel (PDCCH) reception, and wherein the entering condition is satisfied when the value of the interference measurement exceeds a corresponding value threshold.

12. The method of claim 8, wherein the value of the interference measurement is an interference value measured during a generation of a channel quality indicator (CQI) report, and wherein the entering condition is satisfied when the value of the interference measurement exceeds a corresponding value threshold.

13. The method of claim 8, wherein the sending includes sending the one or more reports via one or more slots, one or more symbols, one or more resource blocks, one or more physical downlink control channel (PDCCH) resources, or one or more physical uplink shared channel (PUSCH) resources that are configured by the network node.

14. The method of claim 8, wherein the sending includes sending a report that includes a bit value that indicates a level of the UE-to-UE CLI or a bit value that serves as a pointer to a table that defines different UE-to-UE CLI levels or different UE-to-UE CLI values for various bit values.

15. The method of claim 8, wherein the sending includes sending a report that indicates a resource on which the UE-to-UE CLI is detected, the resource including one or more slots, one or more symbols, one or more resource blocks, or one or more transport blocks.

16. The method of claim 8, further comprising stopping, by the processor, the sending of the one or more reports to the network node when a leaving condition is satisfied, and wherein the leaving condition is satisfied when the value of an interference measurement no longer exceeds the interference threshold.

17. The method of claim 8, further comprising stopping, by the processor, the sending of the one or more reports to the network node when a preconfigured number of reports are sent.

18. The method of claim 8, wherein the sending includes sending consecutive reports according to a reporting interval configured by the network node.

19. The method of claim 8, wherein the sending includes performing semi-persistent sending of the one or more reports using resources that are configured via a higher layer signaling by the network node.

20. The method of claim 8, wherein the sending of the one or more reports is further deactivated or activated by the network node using Layer 1 signaling.
